(19) United States
(12) Patent Application Publication
(10) Pub. No.: US 2006/0036561 A1
(43) Pub. Date: Feb. 16, 2006

(54) Pattern search algorithm for component layout

(75) Inventors: Chandankumar Aladahalli, Pittsburgh, PA (US); Kenji Shimada, Pittsburgh, PA (US); Jonathan Cagan, Pittsburgh, PA (US)

Correspondence Address: Edward L. Pencoske;Jones Day, Suite 3100, 500 Grant Street, Pittsburgh, PA, 15219-2502, US

(73) Assignee: Carnegie Mellon University

(21) Appl. No.: 11/254,842

(22) Filed: Oct. 20, 2005

Related U.S. Application Data
(63) Continuation-in-part of application No. 10/672,442, filed on Sep. 26, 2003.
(60) Provisional application No. 60/414,311, filed on Sep. 27, 2002.

(51) Int. Cl. G06N 5/02; G06F 17/00

(52) U.S. Cl. 706/48

(57) ABSTRACT

A solution to determining the move set ordering in pattern searching is disclosed that involves driving a pattern search algorithm by a metric other than the step size of the patterns. An instance of this metric is the amount of change in an objective function. Preprocessing algorithms are disclosed which quantify the effect each move has on the objective function. Those moves having a greater effect on the objective function are applied before moves having a lesser effect. We call this effect on the object function the sensitivity of the object function to a particular move and present several methods to quantify it. The sensitivity may be expressed as a function or the moves can be ranked and clustered with the pattern search being driven by the ranked moves or the function. The search may also be driven by an expected change in objective function. Because of the rules governing abstracts, this abstract should not be used to construe the claims.

This application is a continuation in part of copending U.S. patent application Ser. No. 10/672,442 filed Sep. 26, 2003 and entitled Sensitivity Based Pattern Search Algorithm for Component Layout, which claims priority from U.S. provisional patent application Ser. No. 60/414,311 filed Sep. 27, 2002 and entitled Sensitivity Based Pattern Search Algorithm for 3D Component Layout, the entirety of which is hereby incorporated by reference.

### BACKGROUND

The present disclosure is directed generally to pattern based search techniques which can be used, for example, for solving packing and component layout problems.

Many mechanical, electronic and electromechanical products are essentially a combination of functionally and geometrically inter-related components. The spatial location and orientation of these components affect a number of physical quantities of interest to the designer, engineer, manufacturer and the end user of the product. Some examples of these quantities are compactness, natural frequency, ease of assembly, routing costs, and accessibility. 3D component layout concerns itself with determining the optimal spatial location and orientation of a set of components given some objective function (i.e., means of measuring if one solution is better than another solution) and constraints. This objective function can include a quantification of a variety of measures such as the amount of cable used in the engine compartment of a car, or the packing density in an electric drill, or the center of gravity of a space vehicle. Constraints could include spatial relationships between components and between a component and the container. The variety of products and layouts that can be dealt within the 3D layout framework is large.

The 3D layout problem can be classified into the following four sub domains: simple 3D layout, 3D layout with optimization, 3D layout with special constraints and3D layout with optimization and 3D special constraints.

The simple 3D layout problem just requires that there be no intersection between components and that there be no protrusion of components outside the container. This problem does not have very many practical applications but is the fundamental problem upon which the problems of the other sub domains are constructed.

The simple 3D layout problem is technically a constraint satisfaction problem defined as: find x₁, x₂, . . . , xₙ such I(x₁, x₂, . . . , xₙ)<ε where I(x₁, x₂, . . . , xₙ) is the sum of the pair wise intersection between components and the protrusion of components outside the container. The arguments x₁, x₂, . . . , xₙ represent the coordinates (x,y,z) of particular points on the different components along three independent axes and the orientations (θ₁, θ₂, θ₃) of the components about three independent axes. ε is the user defined maximum tolerance on intersection and protrusion volumes. We allow a non-zero value for ε because in tight packing situations it is difficult to find a layout with zero intersection and protrusion. It is easier to allow for a small amount of intersection and protrusion (usually less than 1%) of the total volume of components) and then remove it by post processing. The above constraint satisfaction problem is modeled as an unconstrained minimization problem as follows:
Minimize O(x₁, x₂, . . . , xₙ)=I(x₁, x₂, . . . , xₙ).

We hope that by minimizing I(x₁, x₂, . . . , xₙ) we can make it less than ε and thus satisfy the constraint I(x₁, x₂, . . . , xₙ)<ε.

In 3D layout with optimization, apart from avoiding intersections and protrusions, a user defined objective function is required to be minimized. This problem has quite a few applications, examples being SLA container packing (while minimizing height) and center of gravity reduction for a vehicle.

This is a constrained optimization problem where we are required to minimize a user defined function C (x₁, x₂, . . . , xₙ) subject to the same constraint as in simple 3D layout, i.e., minimize C (x₁, x₂, . . . , xₙ) subject to I(x₁, x₂, . . . , xₙ)<ε.

Again we model this as an unconstrained minimization problem by including the constraint in the objective function as follows:

Minimize O(x₁, x₂, . . . , xₙ)=I(x₁, x₂, . . . , xₙ)+ωC(x₁, x₂, . . . , xₙ), where ω is an appropriate weighing factor between the two objective function components.

It can be seen that the parameter ω is critical in solving this problem. An appropriate value for ω needs to be chosen so that the constraint I(x₁, x₂, . . . , xₙ)<ε is satisfied.

3D layout with 3D spatial constraints is a constraint satisfaction problem with additional user defined spatial constraints. This sub domain has a lot of practical applications. These include automobile engine compartment packing, layout of printed circuit board components, and packing in electromechanical devices such as printers and cameras.

Currently the 3D spatial constrains are modeled in the objective function itself as soft constraints, i.e., the constraint violations are penalized by adding their magnitude to the objective function. This may not be the best way to satisfy spatial constraints because the equality constraints may never be satisfied. 3D spatial constraint satisfaction is an active research area on its own and we do not speculate here on the appropriate mathematical model to solve it.

3D layout with optimization and 3D spatial constraints is a combination of the 3D layout with optimization and 3D layout with 3D spatial constraints. As mentioned above, 3D spatial constraint satisfaction is a very difficult problem and we do not speculate about it here.

Many different stochastic search algorithms have been applied to the 3D layout problem. These include genetic algorithms, simulated annealing and extended pattern search (EPS). Extended pattern search is basically pattern search with extensions to make it stochastic. Pattern search uses move sets (patterns) to explore the search space. In 3D component layout, these moves are typically translations and rotations of the components.

Pattern search methods are a subclass of direct search methods that utilize only direct comparisons of objective function values. Direct search methods are well suited for problems in which there is no gradient information available. A variety of direct search methods have been developed and used over the past fifty years. Torczon and Trosset (“From Evolutionary Operation to Parallel Direct Pattern Search: Pattern Search Algorithms for Numerical Optimization,” Computing Science and Statistics 29(1) pp. 396-401 (1997)) explicated the common structure and key features of the above search methods and defined a general framework called the Generalized Pattern Search method (GPS). Torczon also established a rigorous framework to mathematically deal with the above variety of direct search methods and proved their convergence, “On the Convergence of Pattern Search Algorithms.” SIAM Journal of Optimization, 7(1), pp 1-25 (1997).

As the name implies, the General Pattern Search (GPS) algorithm uses the set of patterns Pₖ to explore the search space. For example moving 2 units along the x-direction and 1 unit along the y-direction is a possible pattern in 2D component layout. The magnitude of the steps is controlled by the step size control parameter Δₜ.

In the initial stages of the search the step sizes are large so that the algorithm can reach any point in the search space. As the algorithm proceeds the step size is decreased until a threshold step size is reached after which the algorithm terminates. At a given step size, a trial move is attempted along a pattern direction. Any step that leads to a better state is accepted and a trial move is attempted again and so on. Only when all attempts to make a successful move at a step size have failed, is the step size reduced.

Pattern search developed mainly as a technique for numerical function minimization. Usually the function to be minimized consisted of only a few variables and was non-linear. Yin and Cagan (“An Extended Pattern Search Algorithm for Three-Dimensional Component Layout”, ASME Journal of Mechanical Design, 122(1) pp 102-108 (2000)) first applied the pattern search algorithm to the 3D component layout problem. They introduced several modifications of the algorithm for 3D component layout, resulting in the Extended Pattern Search (EPS) algorithm discussed below. Those modifications include randomized search orders, step jumps, swap moves, and a hierarchical objective function model.

The EPS algorithm begins by taking as input a number of components, a container, an objective function, and constraints. Constraints describe the spatial relations between components and between components and the container. Two sets of pattern directions are used, namely the translation and the rotation pattern matrices. Each component could have a different set of move directions to accommodate the constraints on them. Pattern matrices are essentially chosen to reflect the permitted move directions for each component as well as any additional search strategy.

From an arbitrary initial state of the components, translation moves are first applied. Components are randomly selected and are translated, thus generating a new state. A new state is accepted if it results in an improvement in the objective function, else the original state is retained. This process is repeated for all components. If there is no improvement for any of the translations attempted, the step size for translations is scaled down by a factor less than, but close to 1. Next the rotation moves are applied. A component is picked at random and rotated. The same rules (as for the translation moves) for new state acceptance and step size updating apply here. If none of the translations and rotations results in an improved objective function, swap moves are applied. A swap move swaps the positions of two randomly picked components.

The translation and rotation moves repeat until the stopping criterion is met. The stopping criterion is whether both the translation and rotation step sizes are below a pre-specified tolerance.

The parameters related to pattern search are starting and ending step size, scheduling the various moves and the number of steps between the starting and ending step sizes. The performance of the algorithm depends on the above-mentioned parameters. By performance we mean the quality of the final solution and the time (number of iterations) required to reach it. These parameters occur in all the sub-domains where we use pattern search.

Apart from these for 3D layout with optimization sub-domain, the relative weighting between the two terms in the objective function, ω also needs to be decided. Additionally in sub domains where 3D spatial constraints are involved we will have more parameters to decide depending on the mathematical model and solution algorithm used.

### BRIEF SUMMARY OF THE DISCLOSURE

The present disclosure is directed to a method of performing pattern search characterized by driving the search with a metric other than step size. For example, the metric could be the effect of moves on the objective function.

The present disclosure is also directed to a method comprised of determining the effect of a plurality of moves on a set of components and performing a pattern based search based on the determining. The determining may include ranking each of the plurality of moves based on the change each move has on an objective function and ordering the moves from highest to lowest ranking. The ranking can be performed analytically, probabilistically, or heuristically. The determining may additionally be comprise of dividing the range between highest and lowest rankings into a plurality of intervals and assigning each of the moves to one of the intervals. The assigning may be performed according to either a geometric progression based on the rankings or the rankings themselves.

In an alternative embodiment, the determining may include deriving a function that relates moves to changes in an objective function. The search may be driven by the function.

The present disclosure is also directed to preprocessing methods comprising ranking each of a plurality of moves on a set of components based on the effect each move has on an objective function and ordering the moves from those moves having the highest ranking to those moves having the lowest ranking.

The present disclosure is also directed to a preprocessing method comprised of deriving a function that relates moves to changes in an objective function.

The present disclosure is also directed to a preprocessing method comprising ranking each of a plurality of moves on a set of components based on the effect each move has on an objective function and clustering the moves into intervals based on the ranking.

The present disclosure is directed to a method of determining the effect of a plurality of moves on an expected change in value of an objective function, and performing a pattern based search based on the determined effect. More particularly, a set of patterns that spans a search space is selected. For each pattern in the set of patterns, a mapping between a step size of a pattern and an expected change in value of an objective function is determined. A plurality of moves of patterns is created using the mapping for each pattern. The moves are then applied and the objective function calculated. Those moves that reduce the expected change in value of the objective function are accepted. The process is iteratively formed until some stop criteria is reached.

The present invention is also directed to a preprocessing method that derives a mapping that relates step size of a pattern to the expected change in an objective function.

The present disclosure is also directed to apparatus for performing the disclosed methods as well as storage devices carrying ordered sets of instructions which, when executed, perform the disclosed methods.

### BRIEF DESCRIPTION OF THE DRAWINGS

For the present invention to be easily understood and readily practiced, the present invention will now be described, for purposes of illustration and not limitation, in conjunction with the following figures, wherein:

FIG. 1 illustrates a method for evaluating sensitivity S in two dimensions;

FIG. 2 illustrates the sensitivity of the intersection volume on different moves and step sizes;

FIG. 3 illustrates a preprocessing algorithm;

FIG. 4 illustrates a preprocessing process;

FIG. 5 is a flow chart illustrating one embodiment of a sensitivity-based pattern search;

FIG. 6 is a flow chart illustrating another embodiment of a sensitivity-based pattern search;

FIGS. 7A, 7B and 7C illustrate three test cases;

FIGS. 8A and 8B illustrate the GPS algorithm and the OPS algorithm, respectively;

FIGS. 9A-9D illustrate the objective function variation with successive steps along a pattern on the left and the resultant expected change in objective function value as a function of the step size (solid lines) and fitted power law relation (dashed line) on the right;

FIGS. 10A-10C illustrate packing objects into a sphere, packing objects into a Stereolithography Apparatus (SLA) container while minimizing maximum height and packing objects to minimize the second moment of inertia about a centroid, respectively;

FIG. 11 is a comparison of the results from the GPS and OPS algorithms for the three packing problems (each of the three columns represents two examples each for the three packing problems);

FIG. 12 illustrates the convergence of the objective function value with respect to the number of runs;

FIG. 13 is a comparison of the results from the GPS and OPS algorithms for the two fractal surfaces (the column on the left shows the actual surface);

FIGS. 14A-14D are a comparison of the sensitivity metric (15A) with the expected change in objective function value for three different layout problems;

FIG. 15 is a comparison of the results from the GPS and SPS algorithms for three packing problems;

FIG. 16 is a comparison of the results from the GPS and SPS algorithms on two trunk packing problems;

FIG. 17 is a comparison of the results from the GPS and OPS algorithms for the layout of a PC board;

FIG. 18 is a comparison of the results from the GPS and OPS algorithms for the layout of another PC board; and

FIG. 19 illustrates hardware for implementing the pattern searches disclosed herein.

### DETAILED DESCRIPTION

In this disclosure we present a novel solution to determining the move set ordering in pattern searching. According to a first approach, preprocessing algorithms are disclosed which quantify the effect each move has on an objective function. Those moves having a greater effect are applied before moves that effect the objective function less. We call this effect on the object function the sensitivity of the objective function to a particular move and present several methods to quantify it. Using our disclosed move set ordering, we were able to reduce run-time over traditional pattern searching by up to twenty-five (25%) percent or more. According to another approach, an explicit evaluation of expected change in objective function is performed. Those moves having a greater expected change in objective function are performed first. That approach produces better results although the time saved in performing the search may be offset by the time spent in performing the explicit evaluation. In either case, the pattern search is driven by a metric other than step size.

The most common moves used in 3D component layout are translations and rotations. Starting from an initial configuration, components are translated and rotated until a good packing/layout is achieved. There are three independent axes along which a component can be translated and three independent axes along which it can be rotated. This means that for an unconstrained problem a minimum of six mutually independent patterns per component is required to completely explore the search space, assuming that there is sufficient resolution in the step sizes.

Previously in EPS, no attention was paid to the ordering of these six different moves for the different components. Translations and rotations were applied intermittently and were independent of each other. For each component, at a particular step size, all the translation moves for different components were tried out, and if all of them failed then the step size was reduced. Next, at a particular rotation step size rotation moves for different components were tried. If all of them failed, then the rotation step size was reduced. The translations and rotations started all over again at the new step size.

Observe, however, two characteristics of the EPS algorithm: First, it makes sense to avoid moves such as the rotation of spheres, because they do not affect an objective function like I(x₁, x₂, . . . , xₙ), whereas rotation of objects like cubes does affect the objective function. Second, big step sizes are applied earlier followed by a smaller and smaller step sizes. This is because a move with a larger step size has more effect on the objective function I(x₁, x₂, . . . , xₙ) than a move with a smaller step size. Putting the above two observations together we see that the scheduling of moves can be associated with the sensitivity of the objective function to the different moves. We also see that the sensitivity of the objective function not only depends on the move but also on the step size of the move. We therefore define sensitivity S of the objective function I(x₁, x₂, . . . xₙ) to a move sᵢ^{k} as follows:

$$S = {\int }_{{V}^{′}} r ⅆ V \qquad ( 1 )$$

where V′ is the non-intersecting volume between an object and itself after applying the move sᵢ^{k} and r is the displacement of the infinitesimal volume dV. See FIG. 1 for an analogous 2D example.

From the above definition, the sensitivity associated with a move depends on both V′ and r, i.e., S depends on both the pattern and the step size. Because a pattern includes the object to which it is applied, S depends on the object and hence on its geometry. The above definition quantifies the displacement of an object due to the move. Also this displacement is useful only if it moves a volume element to a place not occupied by the object before the move. Therefore we integrate only over the non-intersecting volume. See FIG. 1. The rationale behind this quantification is that the more non-intersecting volume after a move, the bigger effect the move can have on the intersection and protrusion volume. Also the farther a non-intersecting volume element is displaced, the bigger the effect on the intersection and the protrusion volume. Therefore this definition is representative of the average effect of a move on the objective function I(x₁, x₂, . . . xₙ).

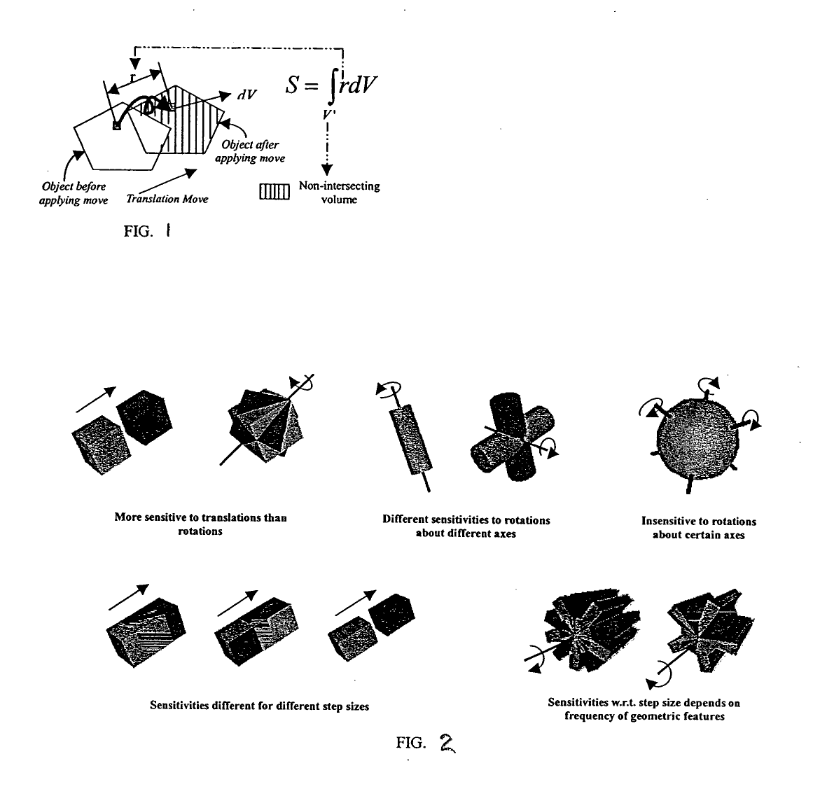

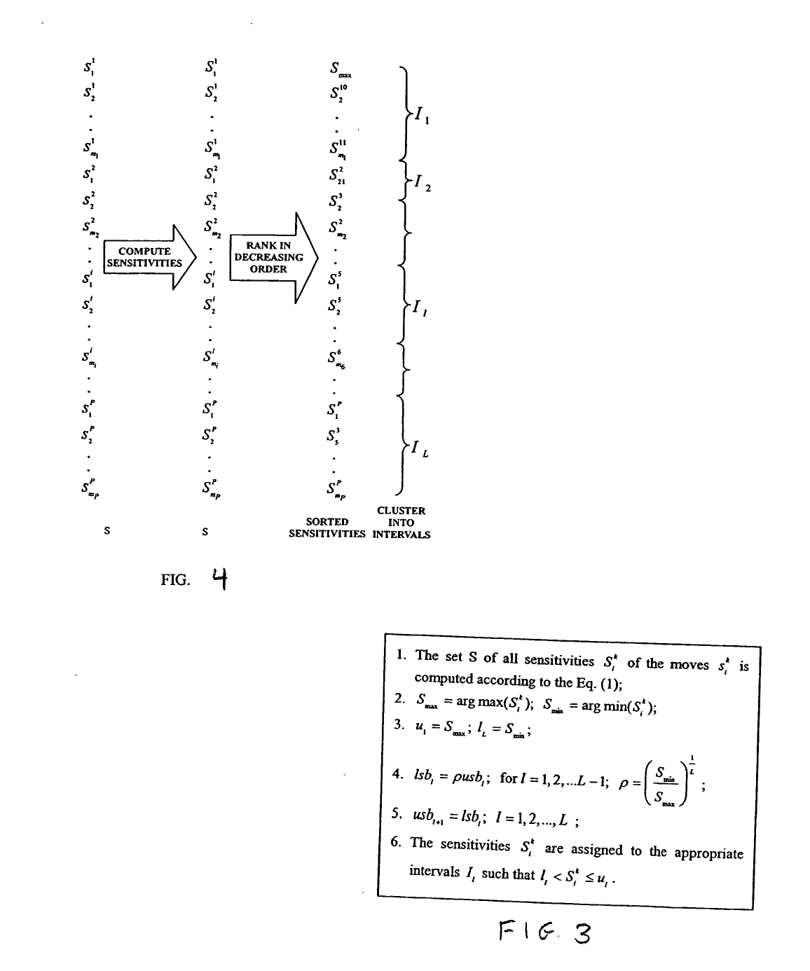

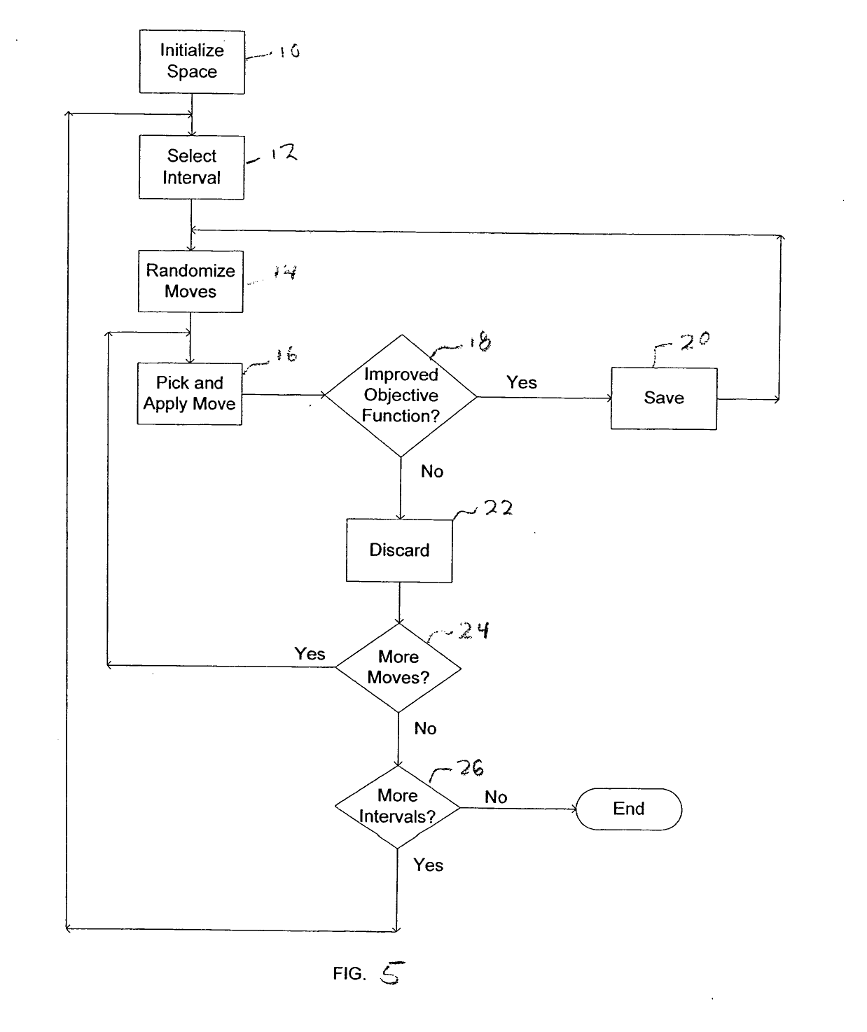

The integral is evaluated as a discrete sum over all the voxels of the object using its octree decomposition. A few examples of the dependence of sensitivity on the pattern and the step size are illustrated in FIG. 2.

We emphasize here that the above definition is not unique, but it serves the purpose of measuring how much a move might affect the objective function. Sensitivity could be derived analytically, probabilistically or heuristically. In a preferred embodiment, sensitivity would be computed in a statistical sense, i.e., conduct a large number of experiments with random placement of the components, apply the move whose sensitivity we are interested in computing and take an average of the change in the objective.

Though the particular definition above for sensitivity is developed with respect to the intersection and protrusion violation I(x₁, x₂, . . . xₙ), the sensitivity-based pattern search (SPS) algorithm based on it does better than the EPS algorithm even for more general objective functions involving additional objectives to optimize. Also, though the above definition is specific to the 3D layout situation, we believe the concept of sensitivity is also applicable to other optimization problems. The difference will be the way in which the sensitivity of the objective function is quantified.

As previously mentioned, our disclosure aspires for bigger improvements first and smaller improvements towards the end. Efficient means that the algorithm with the new order will either give a lower objective function value for the same number of iterations or will take fewer iterations to converge to a similar objective function value as the existing EPS algorithm.

The patterns that are used during the course of the search are denoted by the columns of a matrix Pₖ, see Aladahalli, C., Cagan, J., Shimada, K., “A Sensitivity-based Pattern Search Algorithm for 3D Component Layout”, Proceedings of the ASME DETC 2001, Montreal Canada (2001). In the new SPS algorithm, the set of patterns is fixed and there is no concept of updating the pattern matrix. Hence we drop the subscript k from the matrices. Therefore
P=BC=[BM−BM BL]=[BΓ BL]. (2)

The matrices B and C are required to satisfy conditions placed on them in the original pattern search method.

Δᵢ^{l} and Δᵢ^{m} denote the first and last step size of the i^{th} pattern respectively. As mentioned before a pattern includes the direction of move and the component to which it is applied. Note that the i^{th} pattern takes mᵢ possible step sizes.

A move is defined as the product of the k^{th} step size of the i^{th} pattern Δᵢ^{k}, and the i^{th} pattern Pᵢ.
sᵢ^{k}=Δᵢ^{k}Pᵢ, k=1, 2, . . . , mᵢ. (3)

Here mᵢ is the total number of step sizes for the i^{th} pattern. So the total number of moves M is given by

$$M = {\sum }_{i = 1}^{i = P} {m}_{i} ,$$

where P is the total number of patterns in the pattern matrix. Sᵢ^{k} denotes the sensitivity of the objective function to the move sᵢ^{k}.

A sensitivity interval Iₗ ε (□, □) is defined as
Iₗ≡(usb₁, lsb₁), l=1, 2, . . . , L.

Here usb₁ and lsb₁ are the upper and lower sensitivity bounds of the interval. As we shall see later the interval I₁ contains the moves whose sensitivity lies in the interval defined by (usb₁, lsb₁). L is the total number of intervals.

The SPS algorithm is divided into two parts: preprocessing and search. The preprocessing part basically involves, in one embodiment, calculating sensitivities of each move, ranking them in a decreasing order and grouping them into intervals. The search part does the actual search.

Because the SPS algorithm uses sensitivities to rank the moves, it first calculates the sensitivities of the moves according to Eq. (1) (Step 1 in FIG. 3). From these sensitivities the maximum and minimum values are picked (Step 2 in FIG. 3). The range defined by the maximum and minimum sensitivities is divided into intervals (Steps 3, 4 and 5 in FIG. 3). The basic idea is to cluster the different moves with similar sensitivities into intervals. Currently we simply divide the range between the maximum and minimum sensitivity into intervals geometrically, i.e.,

$${lsb}_{i} = {usb}_{i + 1} and \frac{{lsb}_{i}}{{usb}_{i}} = ρ ,$$

where ρ is a fixed scaling factor that depends on the number of intervals, L (see Step 4 in FIG. 3). Moves are then assigned to appropriate intervals, i.e., the sensitivity value of a move lies between the upper and lower sensitivity values of the interval to which it belongs (Step 6 in FIG. 3). The above method is not necessarily the best way to cluster the different moves, but is effective for this disclosure. Once the moves are thus classified the search begins. FIG. 3 gives an overview of the preprocessing algorithm, showing how sensitivities of moves are calculated, sorted, and then clustered.

Turning now to FIG. 5, the search portion of the SPS algorithm is illustrated. At 10, the space is initialized. At 12, an interval is selected. Thereafter, at 14, the moves are randomized and, at 16, one of the moves is picked and applied. A determination is made at 18 if the move has improved the objective function. If the answer is affirmative, the new layout is saved at 20 and process flow returns to 14. However, if the determination at 18 is that the objective function has not been improved, the new layout is discarded at 22 and a determination is made at 24 if there are more moves to be made. If that determination is answered in the affirmative, process flow returns to 16. If that determination is answered in the negative, another determination at 26 determines whether there are more intervals. If yes, process flow returns to 12 and, if not, the process ends.

Because the first interval contains moves with the highest sensitivity values, and the sensitivities progressively decrease as successive intervals are used, the moves are applied in decreasing order of their sensitivities.

FIG. 5 describes one round of the algorithm. As done with stochastic algorithms, the search may be restarted several times, and the best solution from among the searches may be chosen.

In GPS, at every step size, there are patterns corresponding to all the dimensions of the search space, i.e., at every step size the pattern matrix allows the algorithm to perturb the search space along all possible dimensions. Therefore the step size can be decreased only when after perturbing all the dimensions of the search space, an improved objective function has not been found. This is not guaranteed or required in the new SPS algorithm. An interval may not consist of moves corresponding to all possible search dimensions. For example, in a problem where there are very big objects and very small objects, the early intervals will generally not contain moves corresponding to the very small objects because the sensitivity of such moves is comparatively very small. Hence when the moves from the first interval are applied, the small objects are not perturbed. Even with the same object, such as a cube, big translation moves have higher sensitivity than rotational moves. Therefore the early intervals will not have moves corresponding to the rotation of the cube.

Also GPS employs a single step size control parameter for all the patterns, whereas SPS allows the use of different step size control parameters for each pattern. Therefore in SPS we can have different numbers of steps for each pattern.

Because in GPS all the search dimensions are active at any time during the search it can be shown that it has the property of local convergence. The SPS algorithm however, does not require that all search dimensions be active at any time in the search, and hence does not have the property of local convergence. This can be fixed by including a final interval that consists of moves with the smallest step size of all the patterns.

In the comparison of the GPS algorithm with the new SPS algorithm above, it is seen that pattern search has always been driven by step size, i.e. start with large step size and decrease the step sizes as you proceed with your search. Although the decrease need not always be uniform, step size is the metric which drives the search. In the new SPS algorithm, the search is driven by a metric other than step size, i.e. a sensitivity metric. In the new SPS algorithm, the pattern search is begun with the largest sensitivity metric and decreases this metric as the search proceeds.

To implement the SPS algorithm, a number of parameters must be decided on. The important ones are discussed below. Each is used to tune the performance of the algorithm. In the current implementation these parameters were chosen for the purpose of comparison with the EPS algorithm.

The number and nature of the patterns P: This is obviously problem dependent and therefore there is no general rule. In the current implementation we use 2n patterns, i.e., P=BC=[BM−BM]. Both B and M are identity matrices in our implementation, i.e., each pattern perturbs exactly one variable in the objective function.

The total number of moves

$$M = {\sum }_{i = 1}^{i = P} {m}_{i} :$$

It is obvious that this depends on the number of step sizes for each pattern. In our current implementation all the mᵢ's are equal.

The number of intervals L: Currently we choose L such that we get a solution (objective function value) similar to the EPS algorithm solution. This selection of L allows for comparison with the EPS algorithm.

The different usb₁'s and lsb₁'s: As mentioned above we geometrically divide the sensitivity range to decide the usb₁'s and lsb₁'s. Again we use the geometric decrease only as a starting point. Also, because both GPS and EPS decrease the step size geometrically, we decided to do the same in our new algorithm to allow for comparison.

Definition of sensitivity: The definition of sensitivity according to Eq. (1) is appropriate for the current situation where the objective function is limited to the intersection and protrusion volume component I(x₁, x₂, . . . , xₙ).

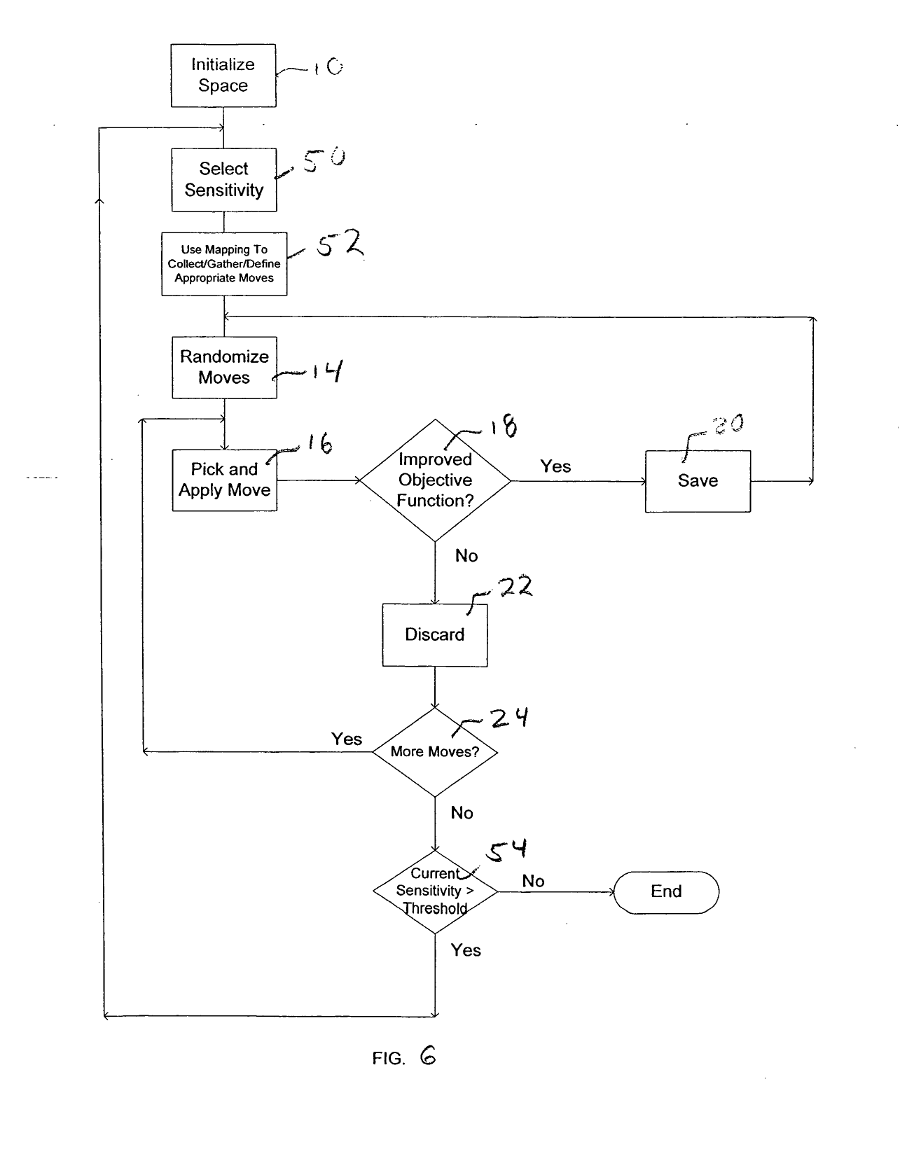

According to another embodiment illustrated in FIG. 6, a different type of preprocessing is performed. In this embodiment, preprocessing is performed so as to derive a function that relates move changes to sensitivities. This function is again derived from the sensitivity as defined in Equation 1. That function is then used to drive the search. For example, if the objective function varies between −1000 and +1000 and does so randomly, the maximum change in objective function value that can be attained is 2000 (1000−(−1000)). The minimum is, of course, 0. The SPS algorithm performs a pattern-based search based on this change in objective function. Thus, the pattern search starts with a parameter such as change_in_objective_function_value equal 2000 and constructs moves for patterns that can give this change. We construct moves corresponding to this value of change_in_objective_function by picking appropriate step-sizes for the patterns. Of course, some patterns may not be able to give a step size which corresponds to a change of 2000 and hence won't be included in a set of moves. Once these moves no longer improve the objective, we choose a smaller change_in_objective_function_value and repeat the process. We keep repeating the process until the change_in_objective_function_value desired falls below a threshold. Thus, the pattern search is now being driven by something other than step-size. This technique is shown in FIG. 6.

In FIG. 6, sensitivity is selected at 50. The selected sensitivity is used to either collect, gather, or define appropriate moves at 52 depending upon the function that has been derived. Thereafter, the process is substantially the same as shown in FIG. 5 except, at the end, instead of determining if there are more intervals, a determination is made at 54 as to whether the current sensitivity is greater than the threshold. If that determination is answered affirmatively, process flow continues with 50. If the sensitivity is below the threshold, the process ends.

### Experiments and Results

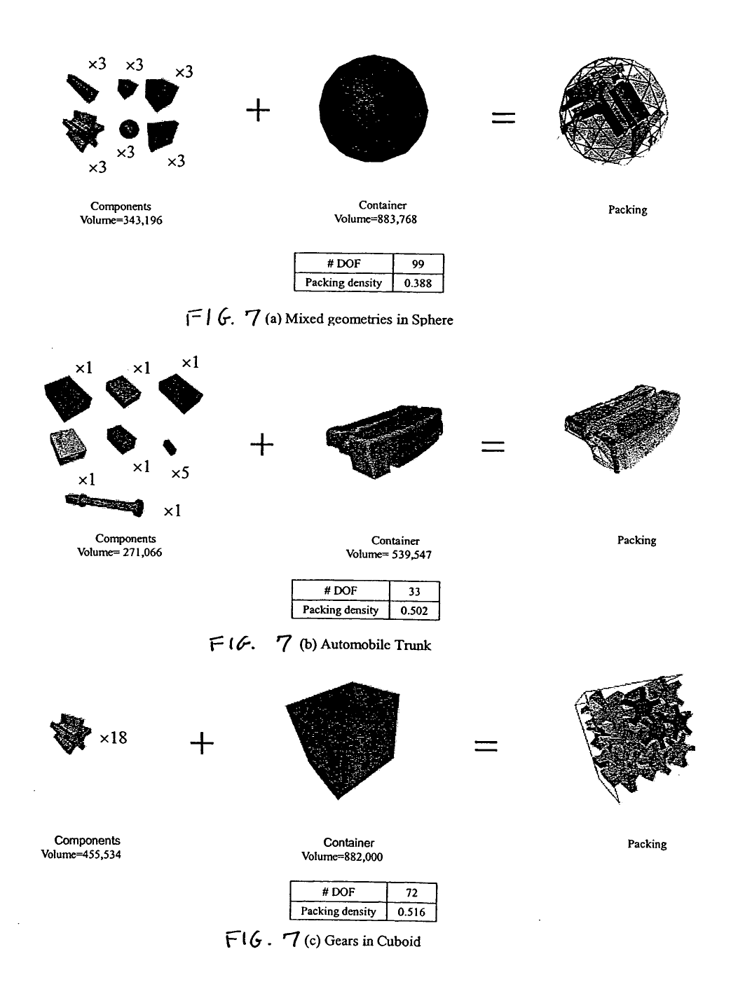

The SPS algorithm was tested on a set of layout problems. In the following examples swap moves were not used. This is not a limitation of the new algorithm, but our current interest was to compare the core pattern search algorithms. Also for the current test the objective function consisted of only I(x₁, x₂, . . . , xₙ). The examples presented below are solvable in the sense that the final intersection and protrusion volume is less than some specified tolerance (1% of volume of components in the examples presented here). The set of test problems is described briefly below. The actual geometries and volume details are shown in FIG. 7

### EXAMPLE 1

Packing three big cubes, three small cubes, three rods, three plates, three gears, and three small spheres into a large sphere.

### EXAMPLE 2

Packing standard (SAE) luggage pieces into the trunk of a car.

### EXAMPLE 3

Eighteen gears packed into a cubic container. The container is sized such that the gears can all fit into the container only if their teeth intermesh.

All the three examples were tested 25 times with both the previous algorithm (EPS) and the new algorithm (SPS). Each test included three runs of the respective algorithm and the best of the three solutions was chosen. Each run started from a random initial configuration. I(x₁, x₂, . . . , xₙ) was evaluated at the sixth level of octree resolution. The number of steps per pattern was 100, i.e., mᵢ=100 for all i.

The averages of the 25 runs are presented in Table 1. From the table, it can be seen that the SPS algorithm required fewer iterations to reach a similar objective function value in all the three examples. The time taken for the preprocessing is negligible (about 1%) compared to the time taken by the search algorithm in SPS.

TABLE 1

| | EPS | | SPS | | $\frac{EPS - SPS}{EPS} \times 100$ | |
|---|---|---|---|---|---|---|
| | Obj. Fn.* | #It- | Obj. Fn.* | #It- | Obj. | #It- |
| | (%)^{$} | erations | (%)^{$} | erations | Fn. | erations |
| Example 1 | 1058 | 28447 | 1052 | 22758 | 0.56% | 20.0% |
| (Sphere) | (0.31%) | | (0.30%) | | | |
| Example 2 | 1769 | 6677 | 1753 | 4766 | 0.89% | 28.6% |
| (Auto | (0.65%) | | (0.64%) | | | |
| Trunk) | | | | | | |
| Example 3 | 1750 | 17105 | 1691 | 14450 | 3.37% | 15.5% |
| (Gears) | (0.39%) | | (0.38%) | | | |

*Objective function is the sum of intersection and protrusion volumes
^{$}Objective function as percentage of volume of components in the packing

The present disclosure introduces a new algorithm, Sensitivity-based Pattern Search (SPS) for 3D layout. This algorithm, though based on the Generalized Pattern Search algorithm accounts for the fact that different moves affect the objective function by different amounts and therefore classifies the moves in decreasing order of their effect on the objective function and applies them in that order. This effect is called the sensitivity.

### Objective Function-Based Pattern Search (OPS)

A second approach is similar in spirit to the GPS algorithm but the driving force is now the effect on the objective function value and not the step size as in the GPS algorithm. In this section we measure the effect on the objective function as the expected change in objective function value. The expected change in objective function value due to a move is the average of the changes to the objective function when the move is applied from all possible locations in the search space. The effect on the objective function can also be measured as the minimum, maximum or any other statistic of the changes in the objective function when moves are applied from all possible locations in the search space. We denote this expected change in objective function value by E. Different patterns result in different values of E at different step sizes. The algorithm depends on a mapping of the patterns and corresponding step sizes to E. This mapping is denoted by E(sᵢ, pᵢ), where sᵢ is the step size and pᵢ is the i^{th} pattern and is defined using a statistical definition of expectation as follows:

$$\begin{matrix}E ( {s}_{i} , {p}_{i} ) = {\int }_{{x}_{1} = {x}_{{1}_{min}}}^{{x}_{1} = {x}_{{1}_{max}}} {\int }_{{x}_{2} = {x}_{{2}_{min}}}^{{x}_{2} = {x}_{{2}_{max}}} ⋯ {\int }_{{x}_{n} = {x}_{{n}_{min}}}^{{x}_{n} = {x}_{{n}_{max}}} \\ \vert f ( x ) - f ( x + {s}_{i} {p}_{i} ) \vert ρ ( x ) ⅆ {x}_{1} ⅆ {x}_{2} … ⅆ {x}_{n}\end{matrix}$$

where, x is the solution vector comprising of the design variables x₁, x₂, . . . , and ρ(x) is the probability of solution x defined as the following uniform distribution.

$$ρ ( x ) = \frac{1}{{\prod }_{i = 1}^{i = n} ( {x}_{{i}_{max}} - {x}_{{i}_{min}} )} .$$

The above definition defines the expected change in objective function value due to a move with step size sᵢ, of a pattern pᵢ as the average of the changes in the objective function value when is applied from all possible points in the search space. The above uniform probability distribution ensures that change in the objective function due to the move from all points in the search space are weighted equally.

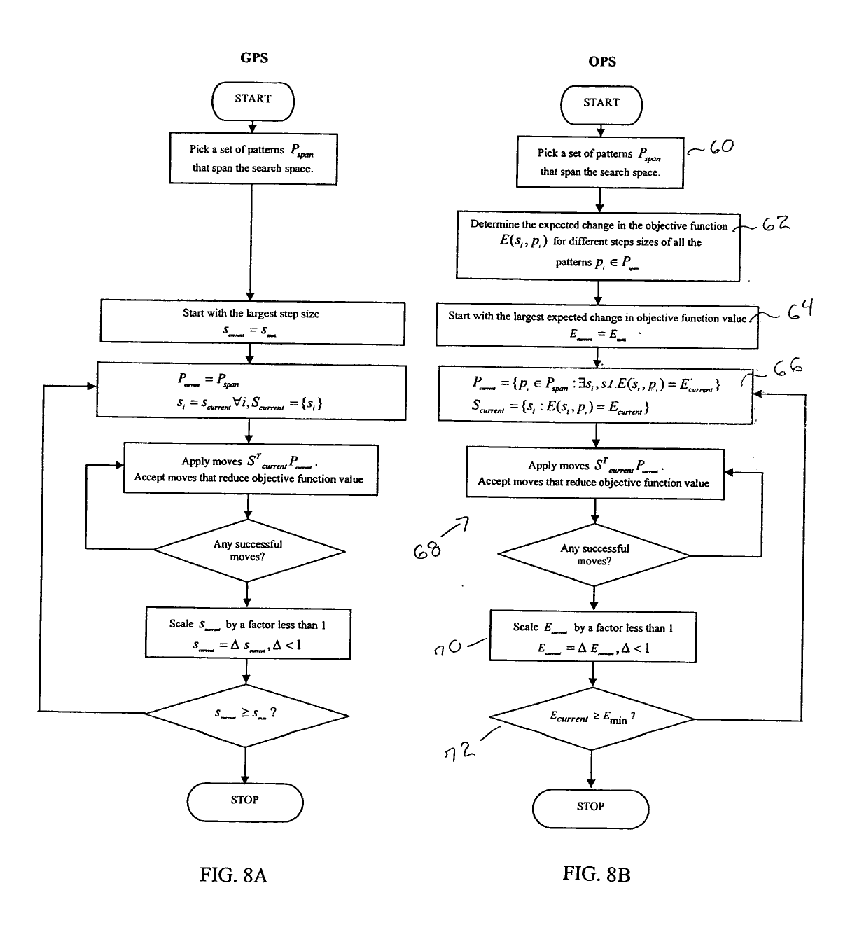

The idea behind the OPS algorithm is that it proceeds by decreasing E. A pattern is introduced into the search only when E falls below the maximum expected change in objective function value at its largest step size, E(sᵢ_{ₘₐₓ}, pᵢ). Thus, patterns are introduced in the decreasing order of their effect on the objective function. Also, a decrease in E results in a decrease in step sizes of the moves, but at different rates for different patterns. The flowchart of the algorithm is presented in FIG. 8B and is contrasted with the GPS algorithm shown in FIG. 8A.

The algorithm begins at 60 with a user defined set of patterns (pattern matrix Pₛₚₐₙ) that span the search space. Next, the mapping between the step size of a pattern and the expected change in objective function value, E(sᵢ, pᵢ), is determined at 62 for all patterns. This step is not required in the GPS algorithm because the GPS algorithm is driven by decreasing step size and not decreasing expected objective function change.

At 64, the algorithm starts with the largest possible expected change in objective function value, Eₘₐₓ. It creates moves of patterns at 66 with step sizes that give Eₘₐₓ using the mapping E(sᵢ, pᵢ). Next, at 68 these moves are applied repeatedly until the objective function ceases to improve. In contrast, the GPS algorithm starts with the largest step size and applies moves corresponding to all patterns at that step size.

Next, at 70 the desired expected change in the value of the objective function, E, is scaled down and moves that give this new E are applied. Once these moves cease to improve the objective function value E is scaled down further. This process continues until a threshold Eₘᵢₙ is reached at 72. In contrast the GPS algorithm successively scales down the step size of the patterns until a threshold step size, sₘᵢₙ, is reached.

Due to the focus on decreasing E, the OPS algorithm differs from the GPS algorithm in two important ways. First, in a given iteration not all patterns are active, i.e., patterns that cannot affect the objective function by the amount E are not included in the pattern matrix. This is because there is an upper bound on the step size of the moves. This upper bound is usually imposed by the size of container or by the space in which the layout is carried out. This means that the set of moves in a particular iteration may not span the entire search space. Whereas, in GPS, at every step size, there are patterns corresponding to all the dimensions of the search space, i.e., at every step size the pattern matrix requires the algorithm to perturb the search space along all possible dimensions, thus satisfying the conditions placed on the pattern generating matrix Cₖ where cₖ=[Mₖ−MₖLₖ]=[ΓₖLₖ]. Therefore the step size can be decreased only when after perturbing all the dimensions of the search space an improved objective function has not been found. This is not guaranteed or required in the new algorithm.

For example, in a problem where the objective is intersection volume and where there are very big objects and very small objects, the early set of iterations in the OPS algorithm will generally not contain moves corresponding to the very small objects because their E is comparatively very small. Hence during initial stages of search the small objects are not perturbed. Even with the same object, such as a cube, big translation moves have higher E than rotational moves. Therefore, in this example, the early iterations will not have moves corresponding to the rotation of the cube.

The second difference between GPS and OPS is that GPS employs a single step size scaling parameter for all the patterns, whereas OPS allows the use of different step size scaling parameters for each pattern. Different step size scaling parameters may result from the rate of change of E for different patterns being different.

For example smaller objects may have a different rate of change of E compared to larger objects. Or rate of change of E for rotations may be smaller compared to that of translations.

### The OPS Algorithm—Determining the Mappings E(sᵢ, pᵢ)

The OPS algorithm uses the expected change in the objective function E(sᵢ, pᵢ) due to the patterns as a measure of their effect on the objective function. We are aware that using the expected change in objective function as a measure of effect on the objective function is very expensive but it serves to build a theoretical framework for scheduling patterns. It is used to demonstrate that it is indeed useful to schedule patterns based on their effect on the objective function.

Given a function ƒ(x₁, x₂, . . . , xₙ), the expected change in objective function value, E(sᵢ, pᵢ) corresponding to pattern pᵢ is obtained as follows. First, ƒ(x₁, x₂, . . . , xₙ) is reduced to a one dimensional (1D) function g₁(s) of the step size, s, of the pattern pᵢ as follows:
g₁(s)=ƒ(x^{•}+spᵢ),
where x^{•} is the vector denoting fixed values of the variables <x₁ x₂ . . . xₙ>^{T}, pᵢ is the pattern of interest and s is the step size of pattern pᵢ.

Next, this 1D function is sampled by applying the pattern at small step sizes successively and computing the objective function value.

This process is repeated for a large number (N) of random valid values for the variables x₁, x₂, . . . , xₙ to derive g₁(s), g₂(s) . . . g_{N}(s). Once g₁(s), g₂(s) . . . g_{N} (s) are available, E(sᵢ, pᵢ) is computed as follows:

$$E ( {s}_{i} , {p}_{i} ) = \frac{{\sum }_{n} {\sum }_{s} \vert {g}_{n} ( s ) - {g}_{n} ( s + {s}_{i} ) \vert}{N • ‖ s ‖} ,$$

where ∥s∥ denotes the number of elements in the inner summation and N denotes the number of functions g₁(s), g₂(s) . . . g_{N}(s) generated from random starting points.

Because the patterns are linear combinations of independent search directions, a large step size is equivalent to the sum of successive smaller step sizes. Hence the change in objective function due to a step size, sᵢ, can be computed by finding the absolute difference between the function g₁(s) at any point s and the same function evaluated at s+sᵢ. The change in objective function is thus computed for multiple functions g₁(s), g₂(s) . . . g_{N}(s) and an average taken to give the expected change in objective function E(sᵢ, pᵢ) due to that step size.

The E(sᵢ, pᵢ) thus mapped has one potential drawback. It might become a constant after a certain step size if the maximum step size is large compared to the size of the component. This is because 3D component layout objective functions are heavily weighed with the amount the intersections and the change in amount of intersection becomes constant once the component is displaced beyond a step size greater than its dimension. If the actual E(sᵢ, pᵢ) becomes constant then two problems arise. First, there is no unique step size that gives the maximum value of expected change in objective function value. This could be resolved by picking the largest step size that gives the maximum expected change in objective function value. But doing so leads to another problem. When the desired expected change in objective function value is reduced from the maximum value, then there is a drastic reduction in step size. This leads to the loss of exploration over a big range of step sizes.

The above problem is resolved by approximating the E(sᵢ, pᵢ) by a power law relation that ensures a strictly decreasing mapping between the step size and expected change in objective function value. A power law relation is defined as follows:
E(sᵢ, pᵢ)=Aᵢ·sᵢ^{e}^{ᵢ}

where Aᵢ and exponent eᵢ are constants specific to pattern pᵢ. A power law also translates into an elegant mapping between the rate of decrease of E and the step sizes corresponding to a pattern. In other words to scale E by a factor Δ, the step size sᵢ needs to be scaled by a factor

$${Δ}^{\frac{1}{{e}_{i}}} .$$

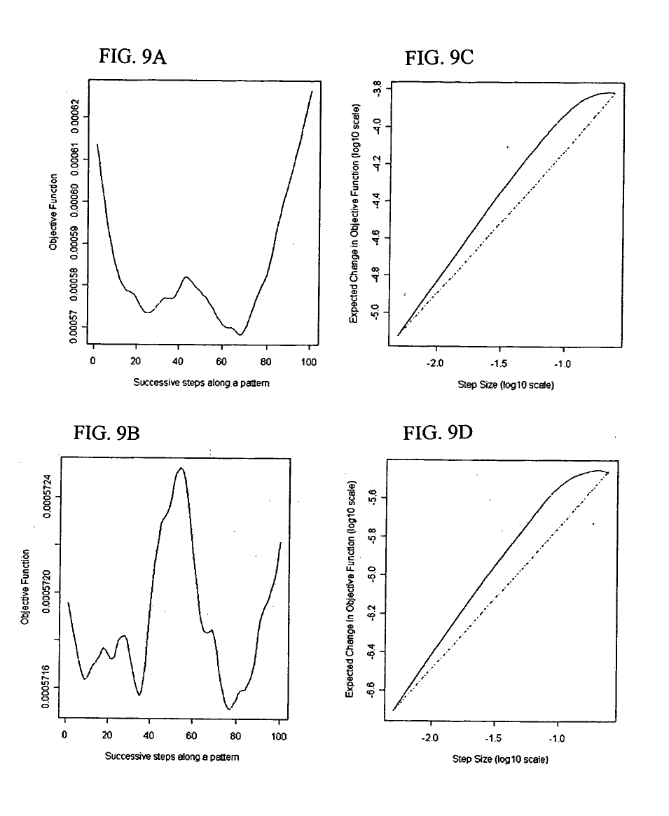

FIGS. 9A-9D show the objective function variation for two different patterns and their respective E(sᵢ, pᵢ) along with the fitted power law relation. As seen in the figure, the power law is fitted by a linear interpolation on the log-log plot of the expected change in objective function vs. the step size. For rotations where the expected change in objective function may be periodic, we fit the power law to the first instance of the period.

Because a power law is fit to the mapping E(sᵢ, pᵢ), the computation of the mapping can be reduced to finding the expected change in objective function for the smallest and the largest step size of a pattern. This is done by finding the difference between objective function values before and after applying moves from a sufficient number (100) of random starting points. This reduces the amount of computation to determine the mapping.

Because the pattern step sizes have an upper bound, the expected change in objective function E(sᵢ, pᵢ) of the patterns also has an upper bound. Different patterns have different upper bounds on their E(sᵢ, pᵢ). The OPS algorithm makes use of these differences in upper bounds to start applying a pattern only when E has fallen below its upper bound. This is the first difference from the GPS algorithm mentioned above.

Also, the because the E(sᵢ, pᵢ) approximations for the different patterns have different exponents eᵢ in their power law relations, their corresponding step sizes will be scaled down at different rates. This is the second difference from the GPS algorithm mentioned above.

### Results

The OPS and GPS algorithms were compared on three different 3D component layout problems. Also, to demonstrate the effectiveness of OPS for minimizing general multi-modal functions, it was compared to GPS on 2D fractal surfaces. The results of the comparison are presented in the following sections.

### A. Results on 3D Component Layout Problems

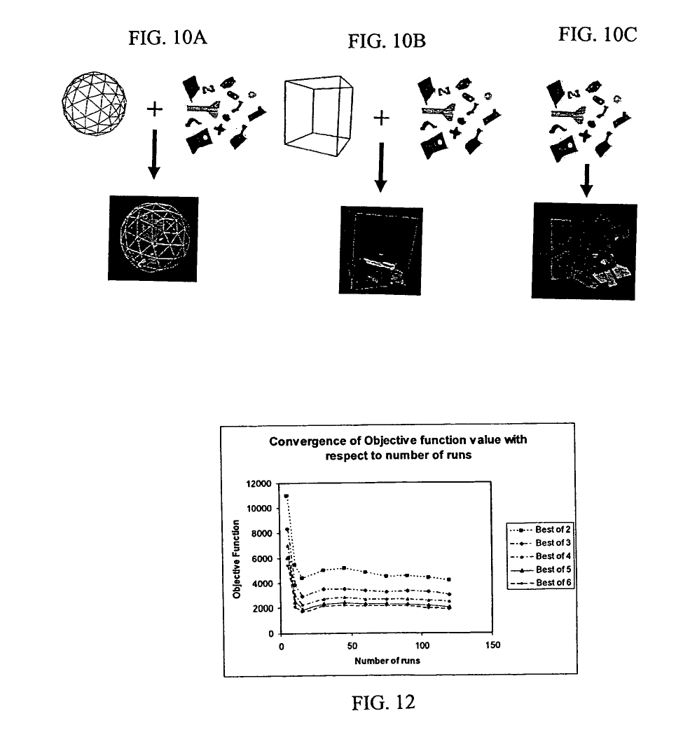

Three different 3D layout spaces were used to compare the performance of the new OPS algorithm with the old GPS and EPS algorithms. The objective functions were 1) sum of pair-wise intersections and protrusions out of container, 2) sum of intersections and protrusions and the maximum height of the packing, and 3) sum of intersections and protrusions and the second moment of the packing about the centroid of the packing. The three examples are shown in FIGS. 10A-10C, respectively. For each of the objective functions, two different problem instances were used for the comparison: one with 13 components and the other with 18 components in the packing.

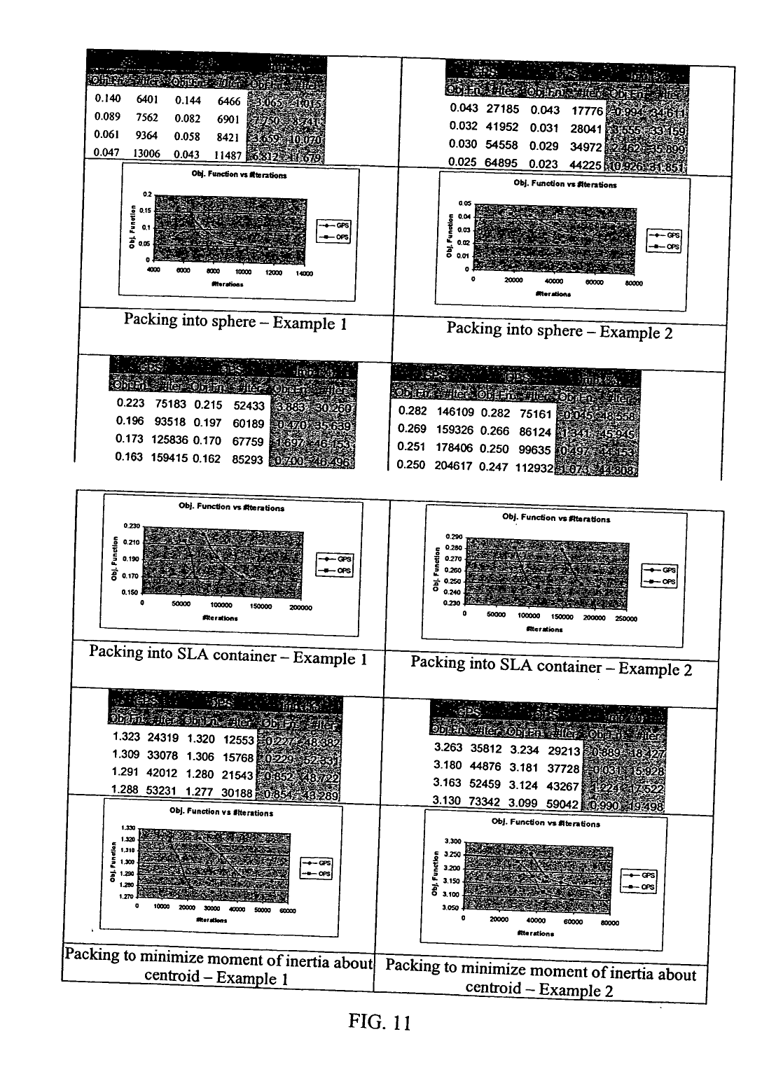

The cuboidal container in packing problem shown in FIG. 11B represents a Stereolithography Apparatus (SLA) working volume. The ultimate goal of this problem is to develop a solution for the minimum height packing problem in SLA containers. The packing problem of FIG. 10C has no container. The objective in this problem was to minimize the second moment of inertia about the centroid of the packing. The second moment of inertia (I) is calculated as follows:

$${I}_{k} = {\int \int \int }_{V} {\vert l - {l}_{c} \vert}^{2} ⅆ V ,$$

where Iₖ is the moment of inertia about the centroid of the packing for the k^{th} component in the packing. |Λ−Λ_{c}| is the Euclidean distance between a point Λ and the centroid of the packing Λ_{c}.

$$I = {\sum }_{k = 1 … n} {I}_{k} ,$$

where n is the total number of components in the packing.

In the examples for packing in SLA container and packing to reduce second moment of inertia about the centroid, the intersection and protrusion component of the objective function was weighted such that the total amount of intersection and protrusion was less than 1% of the sum of volumes of the objects being packed.

The patterns used were translations along three axes and rotations about three axes of each component in the layout and were the same for all the algorithms. The stopping criterion for the GPS algorithm is a threshold step size, whereas the stopping criterion for the OPS algorithm was a threshold E. The threshold E was chosen such that the average step size of the patterns at this threshold is close to the threshold step size of the GPS algorithm.

Results of the new OPS algorithm and the old GPS algorithm are compared in FIG. 11. The three columns show the objective function values and number of iterations for two examples each of the three different packing problems. For each of the examples, the objective function and number of iterations is tabulated and plotted. In the table, the four rows each show the average objective function values and run times (number of iterations) for four different lengths of run. The length of a run affects the final solution quality. The objective function values for the two algorithms were matched as close as possible to make a comparison of the run times. This was done by controlling the number of steps in which the GPS and OPS algorithms decrease the step size and expected change in objective function value, E, respectively.

The results in FIG. 11 are based on 120 runs of each algorithm to generate solutions from different random initial configurations. The 120 runs are divided into 40 sets of three runs each. From each set of three runs, the best solution is picked. From the 40 best solutions thus picked, the average is taken to give the objective function values shown in FIG. 11.

It is a common practice to run stochastic optimization algorithms multiple times from different starting points and pick the best solution. The best solution quality increases with the size of the set from which it is picked. For example, a best of four runs solutions is better than a best of three runs solution. FIG. 12 illustrates the convergence of the objective function with the number of runs for different sizes of the set from which the best solution is picked for one of the examples using the new OPS algorithm. The convergence for the other examples and for the GPS algorithm is similar. It can be seen that the average converges well with 120 runs. For the purpose of comparing the algorithms, we use a best of three runs solution.

The number of iterations required to compute the expected change in objective function value is 15,600 for the first set of objects (13 objects) and 21,600 for the second set of objects (18 objects) for each of the three packing problems. This is as much as the average number of iterations saved by the OPS algorithm as shown in FIG. 11.

### B. Results on 2D Fractal Surfaces

To test the applicability of the OPS algorithm on general multimodal objective functions, we generated 2D fractal surfaces and applied the GPS and OPS algorithms to find the global minima of the surfaces. The objective function value at a location (x, y) is the height of the surface at that point. Fractal surfaces were chosen since a number of engineering optimization search spaces like 2D circuit layout, and 3D component layout have been shown to have fractal properties. A 2D fractal surface is generated by the midpoint displacement of a simplex in 2D and then stretching and truncating this surface along one of the dimensions to make the expected change in objective function values along the two axes different.

The 2D fractal surface was generated as follows. The fractal surface is generated over a 2D array by splitting it into two triangles and generating the surface over them. The function values are defined as zero at the three vertices of a triangle. The triangle is then subdivided into four triangles by adding three new vertices at the midpoints of the edges of the original triangle. The function value at the midpoints of the edges is changed by an amount proportional to the distance between the end points by using a midpoint displacement method described in Peitgen, H., Jurgens, H., Saupe, Dietmar, S., Program of the Chapter: Random Midpoint Displacement, in Chaos and Fractals: New Frontiers of Science. 1992, Springer-Verlag. The function value at the midpoints is modified by an amount Δ=r*s*d^{e}, where r is a random number with a gaussian distribution with mean zero and variance σ, s is a scaling factor in (0, 1), d is the distance between the end points of the edges, and e is the power law exponent and is in (0, 1). The factor s controls the maximum expected change in objective function value and the factor e controls both the maximum expected change in objective function value and the slope of the expected change vs. variable change mapping. The resulting triangles are similarly subdivided until the surface is defined over a sufficient number of points. The other triangle is similarly subdivided to complete a 2D array. The 2D array is then truncated by half along one direction. To make up for the truncated points along that direction, midpoints are added between the remaining points and the height value at these new points is the interpolated values between its neighbors.

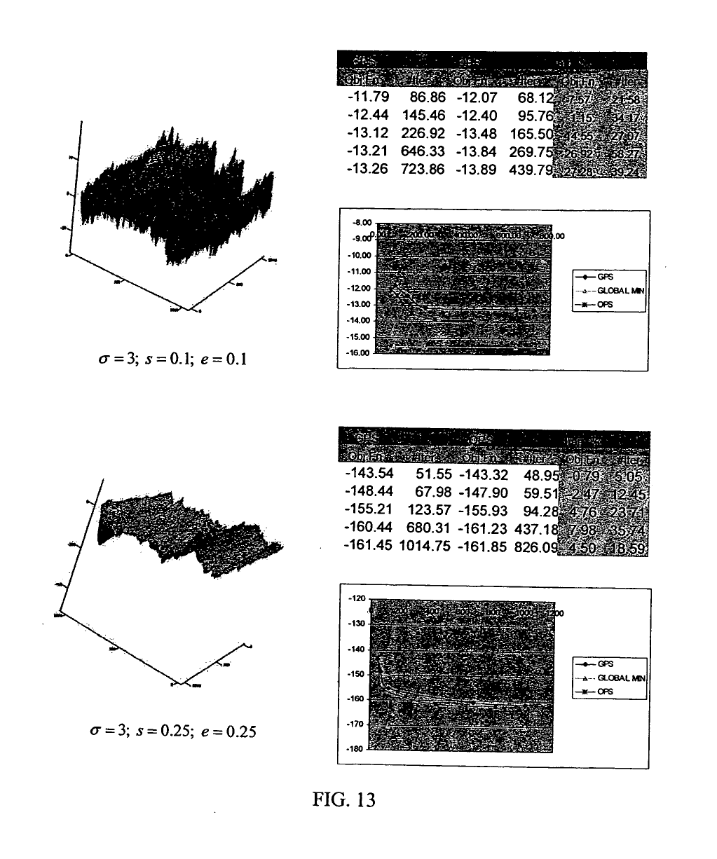

The results comparing the OPS and GPS algorithms on two fractal surfaces are shown in FIG. 13. The five rows in the tables on the right hand side show the objective function value reached and the number of iterations for five different lengths of run.

The results indicate that the new OPS algorithm reduces run time by an average of 30% to yield a similar quality solution. The extended pattern search algorithm (EPS) for 3D component layout differs from the GPS algorithm since it groups the translation and rotation patterns separately. Therefore, to compare the new OPS algorithm with the EPS algorithm we separated the translation and rotation patterns in the OPS algorithm and compared it to the EPS algorithm using the same six 3D component layout examples discussed before. The results were similar to those comparing the OPS and GPS algorithms. It was found that the OPS algorithm with separated translations and rotations runs up to 50% faster than the EPS algorithm.

### Comparison Between the Sensitivity Metric and Expected Change in Objective Function Value

The sensitivity metric was computed for two examples each for the three 3D component layout problems described in FIGS. 10A-10C. The respective objective functions were, as before, 1) sum of pair-wise intersections between components and protrusions of components outside the container, 2) sum of intersections and protrusions and the maximum height of the packing, and 3) sum of intersections and protrusions and the second moment of the packing about the centroid of the packing. The first example had 13 components and the second had 18 components in the packing.

### Comparison Between the Relative Information in the Sensitivity Metric and the Expected Change in Objective Function

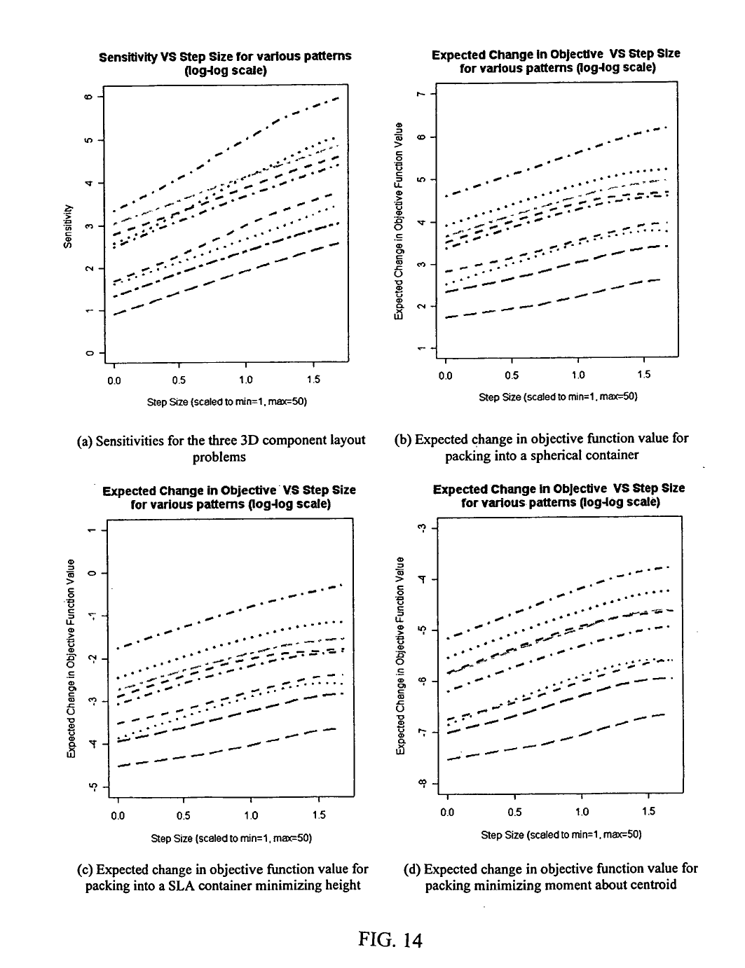

FIGS. 14A-14D compare the mapping between step size and the sensitivity metric and the mapping between step size and the expected change in objective function value for a few patterns in the first example for each of the three 3D component layout problems mentioned above. The same set of components was packed in the three problems and hence they have the same patterns. All four plots are on a log-log scale. The different dotted lines indicate the sensitivities plotted against step size (a) or the expected change in objective function plotted against the step size (b, c and d). Since the sensitivity metric is independent of the objective function, its value is the same for the three different 3D component layout problems. The plots were similar for the second example which had 18 objects in the packing.

It must be noted that the plots shown in FIGS. 14A-D are not directly used in the OPS or the SPS algorithms. Instead, they are approximated by a linear interpolation (on the log-log scale) between the maximum and minimum values, because a linear approximation is a good fit and provides an elegant analytical mapping. Also, it helps in reducing the computation since with the linear interpolation only the maximum and minimum values need to be calculated.

Also, to compare the relative information contained in the sensitivity metric mapping and the expected change in objective function mapping, we computed how well the two mappings matched according to two criteria based on qualitative similarity to each other for the two examples in the three layout problems.

Given two patterns, pᵢ and pⱼ, the first criterion was whether the relative starting values of both the sensitivity and the expected change in objective function value had a similar qualitative relation to each other. For example, if the starting value of the expected change in objective function value of pᵢ was greater than the starting value of the expected change in objective function value of pⱼ, then it was checked whether the starting value of the sensitivity of pᵢ was also greater than the starting value of sensitivity of pⱼ. This was checked for all possible combination of patterns. This criterion reflects whether the order in which patterns are introduced is the same according to both the mappings. In this example, moves of pattern pᵢ are introduced before moves of pattern pⱼ. The results for two packing examples each of the three layout problems are shown in Table 2. More than 90% of pattern pairs have the same order of starting sensitivity as the order of expected change in objective function.

The second criterion was whether pairs of patterns have the same qualitative relation in their slopes in both the sensitivity and expected change in objective function mappings. For example if the slope of the expected change in objective function value of pᵢ was greater than the slope of the expected change in objective function value of pⱼ then it was checked whether the slope of the sensitivity of pᵢ was also greater than the slope of sensitivity of pⱼ. This criterion checks if the relative rates at which the pattern step sizes are decreased are the same qualitatively according to both the mappings. In this example, the step size pattern pⱼ will be decreased faster than that of pᵢ. The results are shown in Table 2. Here the percentage of pattern pairs satisfying the criteria is about 75%.

TABLE 2
Percentage of pattern pairs satisfying the two matching criteria

| | | Criterion 1 | Criterion 2 |
|---|---|---|---|
| Packing in Sphere | Example 1 | 94% | 80% |
| | Example 2 | 89% | 77% |
| Packing in SLA container | Example 1 | 93% | 75% |
| | Example 2 | 93% | 74% |
| Packing to minimize I | Example 1 | 93% | 75% |
| | Example 2 | 92% | 73% |

By the above two criteria, and mappings such as those shown in 14A-14D, we conclude there is a good similarity in the qualitative information contained in the sensitivity mapping and the expected change in objective function mapping.

### Computational Cost Comparison for the Sensitivity Metric and the Expected Change in Objective Function

For preprocessing, a SPS algorithm needs to compute the sensitivity metric at the minimum and maximum step size of every pattern. Therefore for a 3D component layout problem with n patterns, it needs 2n evaluations of the sensitivity metric. Similarly for preprocessing, the OPS algorithm needs to compute the expected change in objective function value at the minimum and maximum step size of every pattern. Therefore 2n evaluations of the expected change in objective function value are required. To compute the expected change in objective function value the average of 50 values of the change in objective function due to the move application is computed. Each change in objective function needs two evaluations of the objective function. Thus a total of 200 evaluations of the objective function is required for the determining the expected change in objective function for a pattern. Therefore for a 3D component layout problem with n patterns, the preprocessing step in the OPS algorithm requires 200n objective function evaluations, a factor of 100 greater than SPS.

Also, computing the sensitivity metric is less expensive than computing the objective function. This is because it involves computing only one intersection, whereas computing the objective function involves computing the intersection of the component with all the other components and the container. Computing the objective function may also involve evaluation of additional terms in the objective function (like maximum height, moment of inertia, etc.). Thus computing the sensitivity mappings is more than two orders of magnitude less expensive than computing the expected change in objective function value mappings.

### Experiments and Results

The SPS algorithm was implemented by replacing the mapping between the step sizes and the expected change in objective function value with a mapping between the step sizes and the sensitivity metric in the OPS algorithm.

The two examples of the three 3D component layout problems mentioned above were solved with the SPS algorithm and their results were compared to those obtained using the GPS and OPS algorithms. Also, two other layout problems were solved with the SPS and the GPS algorithms to show the effectiveness of the SPS algorithm in reducing run time over the GPS algorithm. The first layout problem involved packing SAE standard luggage pieces into automobile trunks. Ding, Q.; Cagan, J. Automated Trunk Packing with Extended Pattern Search. in Proceedings of the 2003 SAE Technical Conferences. 2003. Detroit. The objective minimized was the sum of pair-wise intersections and protrusions out of the trunk. The second layout problem involved the placement of components on a printed circuit board (PCB). The objective was to minimize the sum of pair-wise intersections and protrusions and a measure of wiring length between the circuit elements.

### Comparison Between SPS, OPS and GPS Algorithms on 3D Component Layout Problems

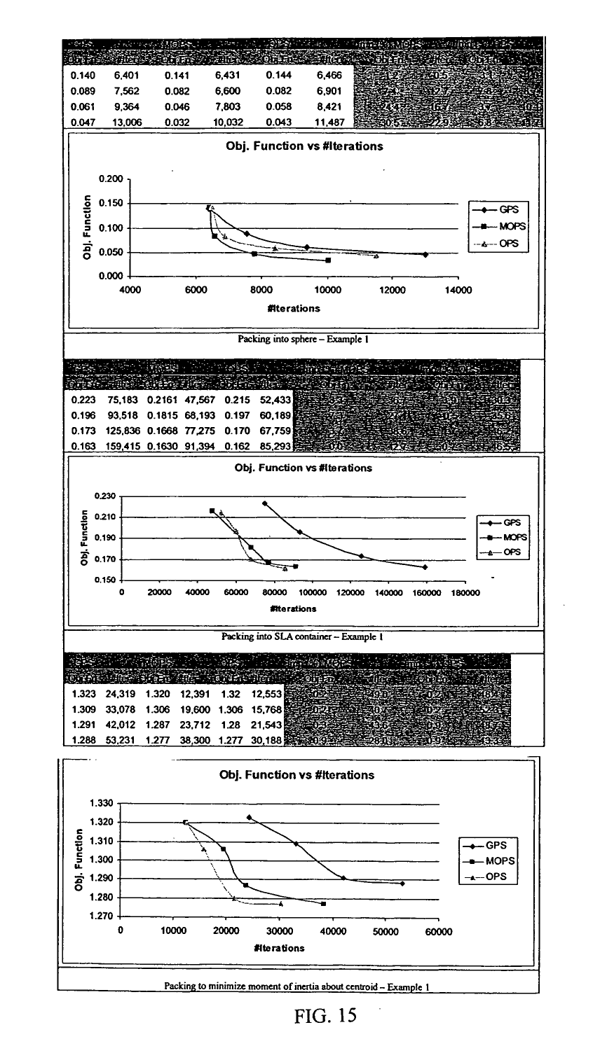

The results from the first example of the three layout problems using the SPS algorithm are shown in FIG. 15. (Note that in this and the following figures, the SPS algorithm is labeled MOPS for Metric Objective-Function-Based Pattern Search). The results are compared with the results obtained by the GPS and OPS algorithms from Aladahalli, C., Cagan, J., Shimada, K., supra. The four rows in the tables in the figure are the results for four different lengths of runs of the algorithms. The objective function values are the average of 40 best of three runs of the algorithm. A best of three runs solution is the best objective function value obtained by running the algorithm three times from different random starting points. The number of iterations shown is the average value for a single run. It can be seen that the SPS (i.e. MOPS) algorithm performs 30% faster than the GPS algorithm on average. The results were similar for the second example for the three layout problems. This improvement in performance is similar to the one obtained by the OPS algorithm in Aladahalli, C., Cagan, J., Shimada, K., supra. But the SPS algorithm does not require the expensive preprocessing step of evaluating the mapping between the expected change in objective function values and the step sizes for the patterns.

The number of sensitivity evaluations for preprocessing in SPS is compared with the number of objective function evaluations for preprocessing in OPS in Table 3. As shown above, the number of iterations required by the SPS algorithm is two orders of magnitude smaller than that for the OPS algorithm. Comparing the number of sensitivity evaluations in Table 3 to the number of objective function evaluations (#Item) in FIG. 15, it can be seen that on average the time required for preprocessing by the SPS is less than one percent of the total iterations needed by the search. It is to be noted that typically a best of three runs solution is used. Therefore the total number of objective function evaluations for the search is three times the number shown FIG. 15. The negligible pre-processing time makes the complete SPS algorithm, including the pre-processing step, run faster than the GPS algorithm.

TABLE 3
Preprocessing times for the SPS and OPS algorithms

| | | | #Objective |
|---|---|---|---|
| | | #Sensitivity | function |
| | | evaluations for | evaluations |
| | | SPS pre- | for OPS pre- |
| | | processing | processing |
| Packing in Sphere | Example 1 | 156 | 15,600 |
| | Example 2 | 216 | 21,600 |
| SLA Packing | Example 1 | 156 | 15,600 |
| | Example 2 | 216 | 21,600 |
| Packing to minimize | Example 1 | 156 | 15,600 |
| moment of inertia | Example 2 | 216 | 21,600 |

The definition of sensitivity metric here is not unique. It is possible to use other metrics that estimate the effect of a pattern move on the objective function. The sensitivity metric was compared with two other similar metrics M′ₛₑₙₛ and M″ₛₑₙₛ shown below

$${M}_{sens}^{′} ( p , s ) = {\int }_{{V}^{′}} \sqrt{r} ⅆ v , {M}_{sens}^{″} ( p , s ) = {\int }_{{V}^{′}} {r}^{2} ⅆ v ,$$

These two metrics are modifications of the sensitivity metric and were constructed to vary the relative importance of intersection avoidance and displacement distance due to a move. One increases the importance of the distance term in the sensitivity metric by using a r² instead of a r term. The other decreases the importance of the distance term in the sensitivity term by using a \sqrt{r} term and thus increases the importance of the intersection volume avoidance.

On the six 3D component layout examples discussed above, the two metrics M′ₛₑₙₛ and M″ₛₑₙₛ performed similarly or up to 10% worse than the sensitivity metric. We believe that by using a linear r term, the sensitivity metric strikes a good balance between accounting for intersection avoidance of a move and the amount by which it displaces a component both of which contribute to affecting the objective function value.

### Comparison on Trunk Packing Problems

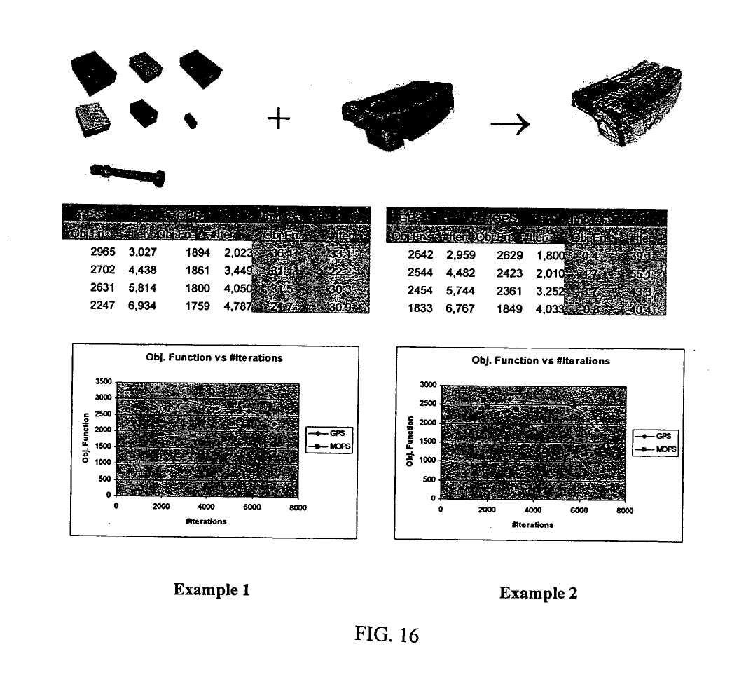

To further explore the effectiveness of scheduling patterns in the SPS algorithm over the GPS algorithm, the two algorithms were compared on two automobile trunk packing instances . Here the objective was to pack a pre-selected set of luggage pieces from the SAE standard luggage set into an automobile trunk. This is a modification of the problem in Ding, Q., Cagan, J. Automated Trunk Packing with Extended Pattern Search. in Proceedings of the 2003 SAE Technical Conferences. 2003. Detroit, where the subset of luggage pieces to be packed had to be chosen by the packing algorithm. Two instances of the problem were used for comparison. The results are shown in FIG. 16. The SPS algorithm gives similar or better packing solution using up to 30% fewer iterations on average.

### Comparison on Circuit Layout Problems

In addition to 3D component layout problems, two 2D circuit layout problems involving printed circuit boards were also solved. Printed circuit boards (PCBs) are physical realizations of topological electric circuits. The physical design of PCBs involves the laying out of electrical packages such as Integrated Circuits (ICs), resistors, and capacitors and routing the connections between them. The placement and routing processes are distinct activities. The actual routing is done either manually or by a routing tool after the placement. However, while placing the electrical packages the routability of the electrical connections between them needs to be taken into account.

The placement of electrical packages is an ideal candidate to be solved by our layout framework as a 2D problem. The packages are represented as 2D polygons and are required to be placed on the board which is itself a 2D polygon. Moreover, these 2D polygons are usually rectangles or combinations of rectangles. Constraints are in the form of fixed locations for packages, areas to keep inside of or remain outside of for packages and distance constraints between the packages.

We model the PCB layout task as a minimization problem where the objective function is the sum of pair wise overlaps between electrical packages and the protrusions of the packages outside the board. To this we also add a measure of proximity of circuit packages that are electrically connected to each other. By minimizing this objective function the pattern search algorithm (GPS or SPS) places highly interconnected packages close to each other.

A 2D version of the sensitivity metric was used to drive the SPS algorithm. The metric is as described above. The patterns used were the translations along x and y axes of the packages.

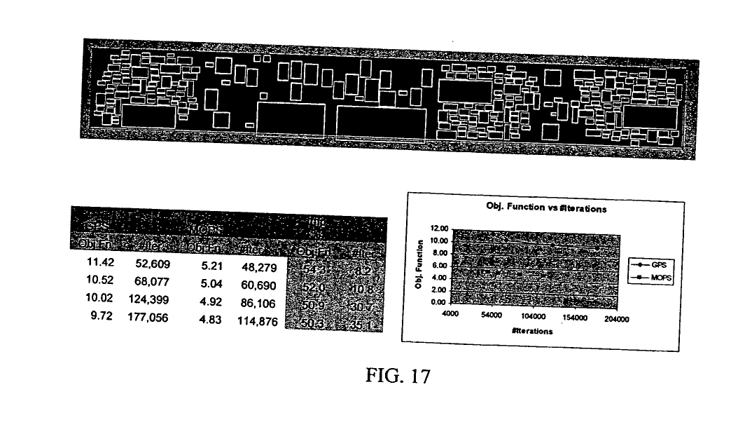

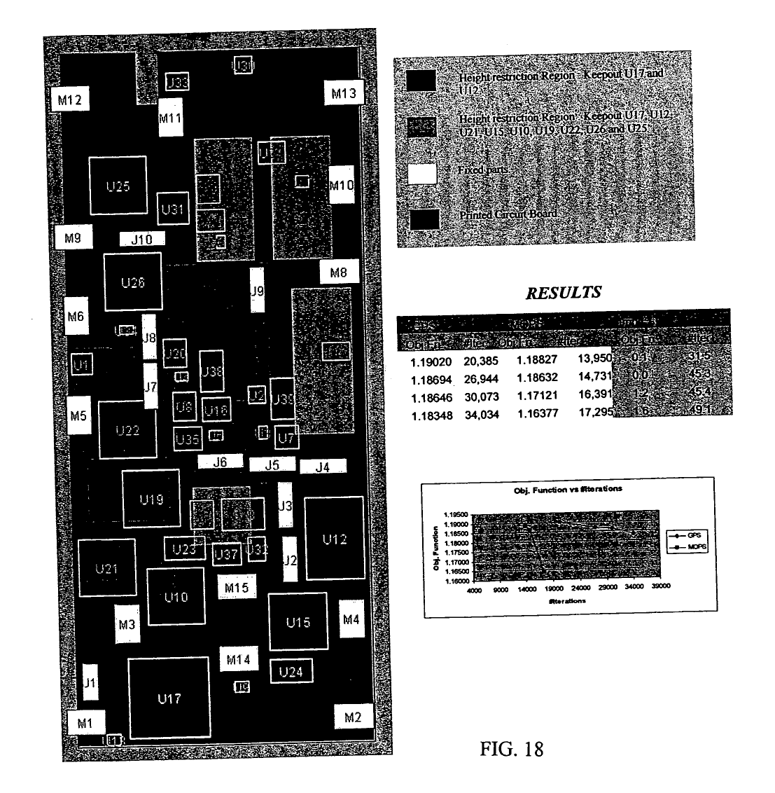

The first problem involves the placement of approximately 250 packages on the board as shown in FIG. 17. The second problem instance involves placement of 36 major components of a circuit on the board as shown in FIG. 18.

The results in FIG. 17 and FIG. 18 show that the SPS algorithm reduces run time by 30% on average. Also the SPS algorithm is able to give better objective function values in the first example. These objective function values could not be obtained by the GPS algorithm by running the algorithm longer with increased number of iterations. This is because the GPS algorithm wastes the large moves of the small packages right in the beginning because it starts applying all patterns at the same time. Hence they are trapped inside bigger objects. In contrast the SPS algorithm applies moves of the bigger packages first. When the placement of the bigger packages is almost decided, the patterns of the smaller packages start being applied. Now these packages can use their initial big moves to escape from local optima to reach a better solution.

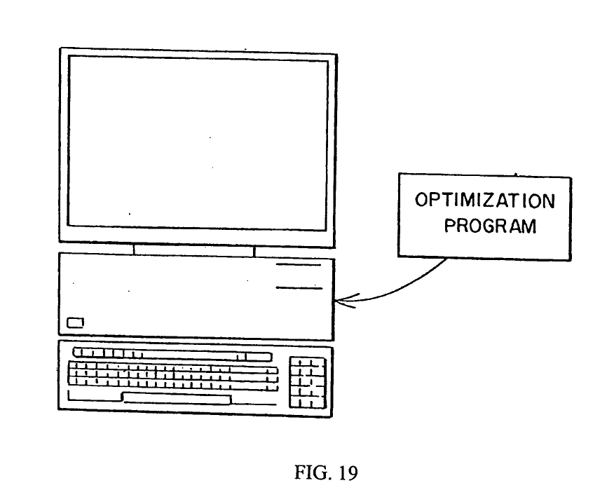

In our preferred embodiment, the methods disclosed herein our embodied in software, stored on any appropriate type of storage medium, and implemented on a computer, as shown in FIG. 19. The computer, as configured by software for performing the methods of the present disclosure, forms an apparatus for performing the methods of the present disclosure.

While the present invention has been described in connection with preferred embodiments thereof, those of ordinary skill in the art will recognize that many modifications and variations are possible. The present invention is intended to be limited only by the following claims and not by the foregoing description.

What is claimed is:

1. A method of performing a pattern based search, characterized by driving the search with a metric dependent on the change in an objective function.

2. The method of claim 1 wherein the metric is one of an expected change in value of an objective function or a sensitivity metric.

3. A method, comprising:
determining an expected change in value of an objective function due to each of a plurality of patterns; and
performing a pattern based search based on said determining.

4. The method of claim 3 wherein said determining includes averaging the changes to said objective function from multiple applications of each of said plurality of patterns.

5. The method of claim 3 wherein said performing includes applying patterns in an order which provides for decreasing changes in said objective function as the search progresses.

6. The method of claim 3 wherein said determining includes performing a mapping between a step size of a pattern and said expected change.

7. A method, comprising:
selecting a set of patterns that spans a search space;
for each pattern in said set of patterns, determining a mapping between a step size of a pattern and an expected change in value of an objective function; and
driving a pattern search using the expected change in objective function.

8. The method of claim 7 wherein said driving comprises:
selecting a largest value of expected change in said objective function as the current desired expected change in objective function value;
creating a plurality of moves of patterns corresponding to the current desired expected change in objective function value by using the said mapping for each pattern;
applying said plurality of moves; and
accepting those of said plurality of moves that reduce the value of said objective function value;
repeating said applying and accepting until a predetermined condition is satisfied;
decreasing said current desired expected change in objective function value; and
repeating said creating, applying, accepting, repeating and decreasing until the desired expected change in objective function value becomes less than a specified threshold.

9. The method of claim 8 wherein said creating includes creating said plurality of moves with those step sizes that provide said desired expected change in the value of said objective function.

10. A preprocessing method, comprising:
deriving a mapping that relates step size of a pattern to the expected change in an objective function.

11. A storage device carrying an ordered set of instructions which, when executed, performs a pattern based search, characterized by driving the search with a metric dependent on the change in an objective function.

12. The storage device of claim 11 wherein the metric is one of an expected change in value of an objective function or a sensitivity metric.

13. A storage device carrying an ordered set of instructions which, when executed, performs a method, comprising:
determining an expected change in value of an objective function due to each of a plurality of patterns; and
performing a pattern based search based on said determining.

14. The device of claim 13 wherein said determining includes averaging the changes to said objective function from multiple applications of each of said plurality of patterns.

15. The device of claim 13 wherein said performing includes applying patterns in an order which provides for decreasing changes in said objective function as the search progresses.

16. The device of claim 13 wherein said determining includes performing a mapping between a step size of a pattern and said expected change.

17. A storage device carrying an ordered set of instructions which, when executed, performs a method, comprising:
selecting a set of patterns that spans a search space;
for each pattern in said set of patterns, determining a mapping between a step size of a pattern and an expected change in value of an objective function; and
driving a pattern search using the expected change in said objective function.

18. The device of claim 17 wherein said driving comprises:
selecting a largest value of expected change in said objective function as the current desired expected change in objective function value;
creating a plurality of moves of patterns corresponding to the current desired expected change in objective function value by using the said mapping for each pattern;
applying said plurality of moves; and
accepting those of said plurality of moves that reduce the value of said objective function value;
repeating said applying and accepting until a predetermined condition is satisfied;
decreasing said current desired expected change in objective function value; and
repeating said creating, applying, accepting, repeating and decreasing until the desired expected change in objective function value becomes less than a specified threshold.

19. The device of claim 17 wherein said creating includes creating said plurality of moves with those step sizes that provide said desired expected change in the value of said objective function.

20. A storage device carrying an ordered set of instructions which, when executed, performs a preprocessing method, comprising:
deriving a mapping that relates step size of a pattern to the expected change in an objective function.

21. A method, comprising:
determining a sensitivity metric due to each of a plurality of patterns; and
performing a pattern based search based on said determining.

22. The method of claim 21 wherein said sensitivity metric is determined as the non-intersecting volume between an object and itself after applying a move.

23. The method of claim 21 wherein said performing includes applying patterns in an order which provides for decreasing changes in said sensitivity metric as the search progresses.

24. The method of claim 21 wherein said determining includes performing a mapping between a step size of a pattern and said sensitivity metric.

25. A method, comprising:
selecting a set of patterns that spans a search space;
for each pattern in said set of patterns, determining a mapping between a step size of a pattern and the sensitivity metric; and
driving a pattern search using the sensitivity metric.

26. The method of claim 25 wherein said driving comprises:
selecting the largest value of said sensitivity metric as the current desired sensitivity metric;
creating a plurality of moves of patterns corresponding to the current desired sensitivity metric by using said mapping for each pattern;
applying said plurality of moves; and
accepting those of said plurality of moves that reduce the value of said objective function value;
repeating said applying and accepting until a predetermined condition is satisfied;
decreasing said current desired sensitivity metric; and
repeating said creating, applying, accepting, repeating and decreasing until the desired sensitivity metric value becomes less than a specified threshold.

27. The method of claim 26 wherein said creating includes creating said plurality of moves with those step sizes that provide said desired sensitivity metric.

28. A preprocessing method, comprising:
deriving a mapping that relates step size of a pattern to a sensitivity metric.

29. A storage device carrying an ordered set of instructions which, when executed, performs a method, comprising:
determining a sensitivity metric due to each of a plurality of patterns; and
performing a pattern based search based on said determining.

30. The device of claim 29 wherein said sensitivity metric is determined as the non-intersecting volume between an object and itself after applying a move.

31. The device of claim 29 wherein said performing includes applying patterns in an order which provides for decreasing said sensitivity metric as the search progresses.

32. The device of claim 29 wherein said determining includes performing a mapping between a step size of a pattern and said sensitivity metric.

33. A storage device carrying an ordered set of instructions which, when executed, performs a method, comprising:
selecting a set of patterns that spans a search space;
for each pattern in said set of patterns, determining a mapping between a step size of a pattern and a sensitivity metric; and
driving a pattern search using the said sensitivity metric.

34. The device of claim 33 wherein said driving comprises:
selecting a largest value of the sensitivity metric as the current desired sensitivity metric value;
creating a plurality of moves of patterns corresponding to the current desired sensitivity metric value by using said mapping for each pattern;
applying said plurality of moves; and
accepting those of said plurality of moves that reduce the value of said objective function value;
repeating said applying and accepting until a predetermined condition is satisfied;
decreasing said current desired sensitivity metric value; and
repeating said creating, applying, accepting, repeating and decreasing until the desired sensitivity metric value becomes less than a specified threshold.

35. The device of claim 34 wherein said creating includes creating said plurality of moves with those step sizes that provide said desired sensitivity metric.

36. A storage device carrying an ordered set of instructions which, when executed, performs a preprocessing method, comprising:
deriving a mapping that relates step size of a pattern to a sensitivity metric.
